(19) United States
(12) Patent Application Publication
(10) Pub. No.: US 2003/0012564 A1
(43) Pub. Date: Jan. 16, 2003

(54) Aircraft water heater

(76) Inventor: Humberto Brache, Santa Clarita, CA (US)

Correspondence Address: RUSS, AUGUST & KABAT, Suite 522, 2361 Jefferson Davis Highway, Arlington, VA, 22202, US

(21) Appl. No.: 10/191,511

(22) Filed: Jul. 10, 2002

Related U.S. Application Data
(60) Provisional application No. 60/303,894, filed on Jul. 10, 2001.

(51) Int. Cl. H05B 3/78; H05B 1/02

(52) U.S. Cl. 392/451; 219/518

(57) ABSTRACT

The water heater has a built-in float switch working in conjunction with an external relay to prevent electrical power from being supplied to the heating element when there is no water in the tank. The heating element draws 6.5 amps of current and has an adjustable thermostat to heat the water to anywhere between 105° F. to 190° F. (41° C. to 85° C.). The water tank is made up of material such as polypropylene that will not burst when the water inside the tank is subjected to freezing temperatures over an extended period of time.

This application claims benefit of provisional application 60/303894, filed Jul. 10, 2002.

### FIELD OF THE INVENTION

The invention relates to a water heater used for an aircraft.

### BACKGROUND OF THE INVENTION

Airplanes of all sizes, from the small King Air and Gulfstream jets to passenger carriers including the 747, include bathroom facilities and a galley. Both the bathroom and the galley require a supply of hot water. The temperature and the amount of hot water made available need to be sufficient to satisfy the needs of the passengers on the plane. In some jets favored by executives, the bathrooms include a shower.

Current water heaters used on board aircraft utilize electrical heating. Water is passed across heated elements inside a cylindrical noninsulated tank controlled by an internal thermostat. This system does not provide an adequate supply of hot water in terms of either temperature or amount. Also, the system draws a large amount of power.

There is a need in the prior art for a water heater that is safe to use aboard aircraft of varying sizes. Also, a water heater used in aircraft needs to withstand freezing temperatures for those occasions when an aircraft is left in a hangar over night and temperatures remain below freezing for an extended period of time. The water heater needs to provide an adequate amount of water for use aboard the aircraft during flight, but not occupy a large amount of space. When used within the tight confines of an aircraft, the electrical relays must be easily replaceable as they are an item subject to failure.

It is an object of the invention to provide a water heater useable aboard an aircraft.

It is another object of the invention to provide a water heater having a sensor mounted within the water tank that indicating when the tank is full of water before allowing heating.

It is another object of the invention to provide a water heater made of material that will not rupture when subjected to freezing conditions.

It is another object of the invention to provide a water heater with external electrical relays that are easily replaceable.

It is another object of the invention to provide a water heater producing an adequate amount of hot water for use by passengers aboard an aircraft.

### SUMMARY OF THE INVENTION

The water heater has a built-in float switch working in conjunction with an external relay to prevent electrical power from being supplied to the heating element when there is no water in the tank. The heating element draws 6.5 amps of current and has an adjustable thermostat to heat the water to anywhere between 105° F. to 190° F. (41° C. to 85° C.). The water tank is made up of material such as polypropylene that will not burst when the water inside the tank is subjected to freezing temperatures over an extended period of time.

### BRIEF DESCRIPTION OF THE DRAWINGS

FIG. 1 is an exploded view of the aircraft water heater.

FIG. 2 is a view of the water heater with portions broken away to show detail.

FIG. 3 is a schematic drawing of the water heater and faucet connections.

FIG. 4 is a schematic view of the wiring diagram for the water heater.

FIG. 5 is a view of the float switch used with the water heater.

### DETAILED DESCRIPTION OF THE INVENTION

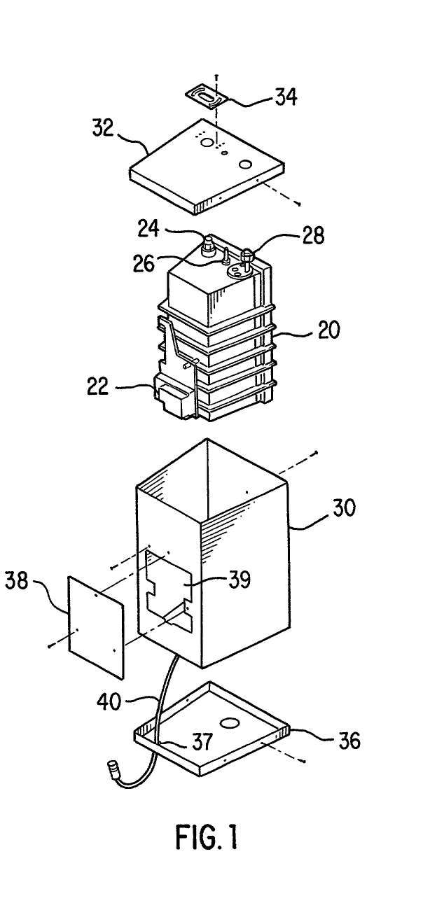

A view of the components making up the water heater 10 is seen in the exploded view of FIG. 1. The tank 20 is formed of polypropylene. If the aircraft is left in a hangar overnight under freezing conditions and the water remaining in the tank freezes, the expansion of the water will not cause the tank to rupture. The tank is designed to operate with a small amount of air at the top to prevent tank damage if freezing occurs.

The tank includes a thermostat 22 for controlling the temperature to which the water is heated. The water can be heated to temperatures from 105° F. to 190° F. This range allows the water to be used in the sink of a bathroom or galley but, if turned to the higher end of the temperature scale, to be used in the preparation of hot beverages. The tank 20 is provided with stainless steel fittings. The inlet fitting 24 receives cold water from the water supply on board the aircraft. The outlet fitting 28 supplies hot water to a faucet. A float switch is combined with the outlet fitting as will be described later. An air vent 26 prevents the tank from becoming pressurized during its operation.

The tank 20 is held within a housing 30. The housing is made of stainless steel or cold rolled steel and insulation is placed between the tank 20 and the housing 30. The insulation allows the outside of the water heater to remain cool to the touch and results in energy savings due to the increased heat retention. A top cover 32 and base 36 are attached to the housing 30 by screws. The top cover has an inlet locking plate 34 and the base has a grommet 37 to allow for the egress of a wiring harness 40. A front cover 38 covers an access opening 39 in the housing. The access opening 39 allows users to adjust the thermostat 22.

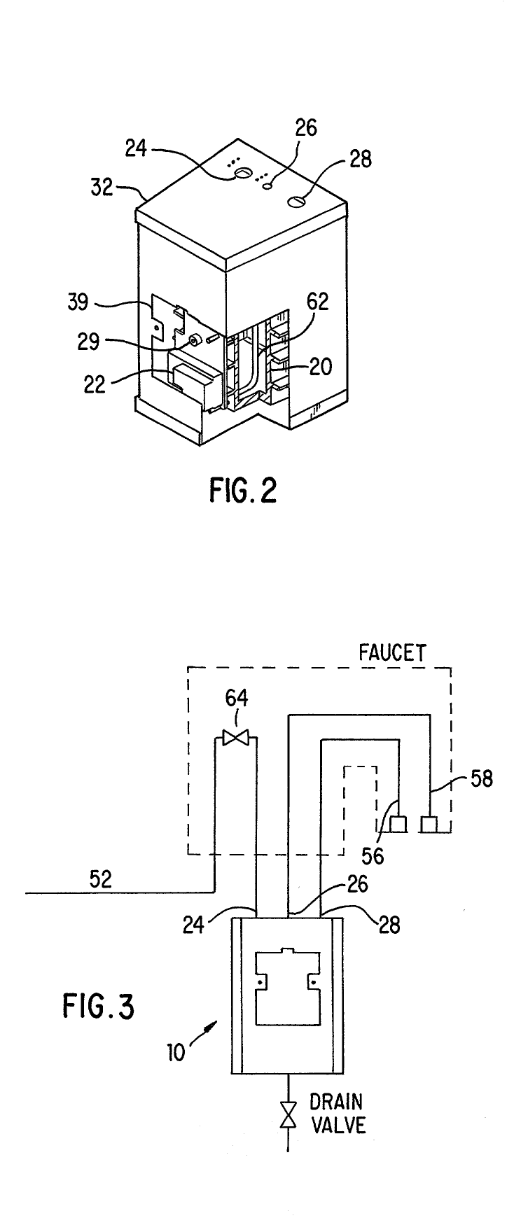

The assembled water heater is seen in FIG. 2 with portions broken away to show detail. The water tank 20 is broken away to reveal the heater element 62. An overheat switch 29 is located above the thermostat 22 and accessible by users when the front cover 38 is removed. The overheat switch protects the tank in the event that the thermostat fails. The overheat switch utilizes a bimetal disk electrically and thermally inflated from the switch. The contacts are normally closed, but open when the set point temperature is reached. The circuit remains open until the manual reset button is depressed at approximately 30% below its operating temperature.

FIG. 3 is a schematic view of plumbing connections with the water heater 10. The normal operation of the unit is such that when the hot water faucet is operated, cold water flows through the water inlet 52, through the now open faucet valve 54 into the tank 10. The influx of cold water into the tank force the hot water through the hot water conduit 56 out of the faucet. Since the tank is provided with an air vent conduit 58, the tank will not pressurize. Due to the operation of the system, some slight delay may be experience when the handle is depressed before hot water travels through the faucet.

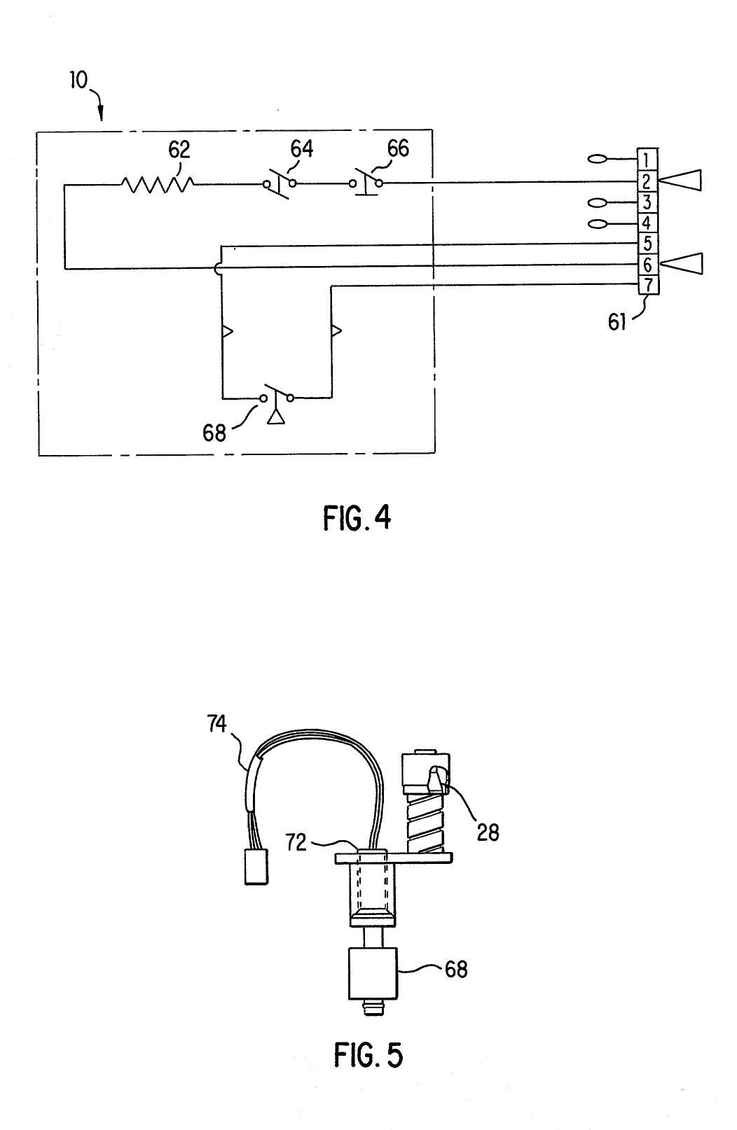

The electrical circuits of the water heater 10 are shown in FIG. 4. A wiring harness 61 supports two circuits. The first circuit contains the heater element 62. In series with the heater element 62 is a variable temperature control 64 and overheat switch 66. The overheat switch provides protection and in the case of the malfunctioning of the variable temperature control to ensure that the water does not become too hot as to cause personal injury. The second circuit includes a float switch 68. This circuit does not allow power to be provided to the heater element 62 unless the tank is substantially filled with water.

The float switch 68 is seen in detail in FIG. 5. In this embodiment, the float switch is made as one piece with the hot water outlet 28. The combined water outlet 28 and float switch 68 has a base 72 supporting both components. The base is attached to the top of the tank 20 to secure the components in place. The float switch 68 extends into the tank and creates a closed circuit only when water in the tank has reached the level as to reach the switch. A wire assembly 74 extends from the float switch 68 and connects to the wiring harness to allow power to be supplied into the heating element when the tank is full.

While the invention has been described reference to a preferred embodiment, variations and modification would be apparent to one of ordinary skill in the art without departing from the scope of the invenvtion. The invention encompasses such variations and modifications as set forth in the appended claims.

What is claimed is:

1. A water heater comprising
a tank for holding water,
a heater element inside said tank, said heater element connected to a power source,
a float sensor inside said tank, said float sensor preventing power to said heater element unless the float sensor senses water.

2. The water heater of claim 1, further comprising
a water inlet fitting and
a water outlet fitting, said water outlet fitting having a base, said float sensor depending from said base.

3. The water heater of claim 1, further comprising
a housing surrounding said tank, and
a thermostat on said tank.

4. The water heater of claim 1, wherein
said float sensor allows power to said heater element only when said tank is substantially full of water.

5. The water heater of claim 3, further comprising
an overheat switch for preventing overheating of the water in the event of failure of the thermostat.

6. A water heater, comprising
a tank for holding water,
a heater element inside said tank for heating water in the tank,
a housing surrounding said tank,
a power source,
a circuit providing power from said power source to said heater element,
relays in said circuit, said relays located externally of said housing.

7. An aircraft, comprising
a cabin for accommodating passengers
a water heater in said cabin for providing heated water, said water heater comprising
a tank for holding water, said tank made of flexible material,
a heater element inside said tank,
a housing surrounding said tank.

8. The aircraft of claim 7, wherein
said tank material is polypropylene.

9. The aircraft of claim 7, further comprising
insulation between said tank and said housing.

10. The aircraft of claim 7, further comprising
a water inlet on said tank, and
a water outlet on said tank.

11. The aircraft of claim 7, further comprising
a thermostat in said tank for controlling the temperature of water in the tank.

12. The aircraft of claim 7, further comprising a air vent on said tank.

13. The aircraft of claim 10, further comprising
a water conduit connected to said water inlet, and a valve in said water conduit for controlling water flow from said tank.

14. The aircraft of claim 13, further comprising
a sink having a faucet for dispensing heated water from said water heater, wherein said faucet is said valve for controlling water flow from said tank.
